(19) United States
(12) Patent Application Publication
(10) Pub. No.: US 2006/0280881 A1
(43) Pub. Date: Dec. 14, 2006

(54) Liquid crystal display device and method of fabricating the same

(75) Inventor: Su Hyun Park, Gyeonggi-do (KR)

Correspondence Address: JENKENS & GILCHRIST, P.C., 901 15TH STREET N.W., SUITE 900, WASHINGTON, DC, 20005, US

(73) Assignee: LG.PHILIPS LCD CO., LTD., Seoul (KR)

(21) Appl. No.: 11/451,481

(22) Filed: Jun. 13, 2006

(30) Foreign Application Priority Data
Jun. 14, 2005 (KR) 10-2005-0051034

(51) Int. Cl. C09K 19/00

(52) U.S. Cl. 428/1.26; 428/1.25; 427/532; 427/162

(57) ABSTRACT

An LCD device includes first and second substrates, an alignment layer formed on at least one of the substrates, and a liquid crystal layer formed between the substrates, wherein the alignment layer is formed of a polymeric material containing a polymer main chain and a photo-reaction group combined with the polymer main chain that generates a photo-dimerization reaction by UV rays.

This application claims the benefit of the Patent Korean Application No. P2005-0051034, filed on Jun. 14, 2005, which is hereby incorporated by reference as if fully set forth herein.

### BACKGROUND OF THE INVENTION

1. Field of the Invention

The present invention relates to a liquid crystal display (LCD) device, and more particularly, to a liquid crystal display devices and method of fabricating the same. Although the present invention is suitable for a wide scope of applications, it is particularly suitable for an alignment layer for initial alignment of a liquid crystal molecules in a liquid crystal layer in an LCD device.

2. Discussion of the Related Art

Among ultra thin flat panel display devices having a display screen of with a thickness of only several centimeters, LCD devices have been widely used as monitors in notebook computers, televisions, spaceships and aircraft due to the LCD having the features of low driving voltage, low power consumption and light weight. In general, an LCD device includes a color filter substrate having color filter layers formed thereon, a thin film transistor substrate facing the color filter substrate and having thin film transistors formed thereon, and a liquid crystal layer formed between these substrates. In such an LCD device, alignment of the liquid crystal molecules in the liquid crystal layer is varied by application of voltage to control transmittance of light, thereby allowing an image to be produced. For example, electrodes are formed on the thin film transistor substrate and/or the color filter substrate for the application of the voltage such that a pixel electrode is located on the thin film transistor substrate and a common electrode is located on the color filter substrate so as to generate a vertical electric field between the two substrates, such as a twisted nematic (TN) mode. In another example, the pixel electrode and the common electrode are located parallel to each other on the thin film transistor substrate so as to generate a horizontal electric field, such as an in-plane switching (IPS) mode.

FIG. 1 is an exploded perspective view illustrating a related art TN mode LCD device. As shown in FIG. 1, a thin film transistor substrate 10 includes a gate line 12, a data line 14 crossing the gate line 12, a thin film transistor T formed adjacent to the crossing of the gate line 12 and the data line 14, and a pixel electrode 16 connected to the thin film transistor T. A color filter substrate 20 includes a light-shielding layer (or black matrix) 22, red, green and blue color filter layers 24 formed in the light shielding layer 22, and a common electrode 25 formed on the color filter layers 24. The thin film transistor substrate 10 and the color filter substrate 20 are bonded to each other to form a liquid crystal panel. A liquid crystal layer (not shown) of liquid crystal molecules is formed between the substrates 10 and 20. When a vertical electric field is generated between the pixel electrode 16 on the thin film transistor substrate 10 and the common electrode 25 on the color filter substrate 20, realignment or reorientation of the liquid crystal molecules (not shown) between the thin film transistor substrate 10 and the color filter substrate 20 occurs.

If the liquid crystal molecules are randomly arranged between the substrates 10 and 20, it is difficult to achieve a consistent arrangement of molecules in the liquid crystal layer. Thus, although not shown in the drawings, an alignment layer for initially aligning the liquid crystal molecules is formed on the thin film transistor substrate 10 and/or on the color filter substrate 20. Examples of a method for forming an alignment layer for initial alignment of the liquid crystal include a rubbing alignment method and a photo-alignment method.

In the rubbing alignment method, after an organic polymer, such as polyimide is thinly coated on a substrate, a rubbing roll wound with a rubbing cloth is rotated to rub the organic polymer, Such a rubbing arranges the organic polymer in a constant direction. However, the rubbing alignment method has the following drawbacks.

First, when the arrangement of the rubbing cloth becomes disordered, a light leakage problem may occur. FIG. 2 is a schematic perspective view illustrating a disordered rubbing cloth. A portion 32a of the rubbing cloth 32 wound around the rubbing roll 30 can become disordered when the rubbing roll 30 rotates on the structure formed on the substrate 10 or 20 as shown in FIG. 2. As such, when the arrangement of the rubbing cloth becomes disordered, the chains of the organic polymer in a region rubbed by the disordered rubbing cloth cannot be aligned, resulting in light leakage in that region due to non-uniform alignment of the liquid crystal molecules.

Second, when the rubbing cloth fails to contact the substrate, the problem of light leakage may occur. FIG. 3 is a cross-sectional view illustrating the rubbing cloth failing to contact the substrate. As described above, the electrode layers such as the pixel electrode and common electrode are formed on the substrates. Thus, as shown in FIG. 3, the rubbing cloth 32 fails to contact the substrate in a region A due to a step on the substrate 10. In this case, the alignment of the liquid crystal molecules is not uniform in the region A, thereby causing the problem of light leakage. In the TN mode LCD device, since the pixel electrode and the common electrode are formed in pixel regions on different substrates, respectively, there may not be so many regions having the steps formed thereon. However, in the IPS mode LCD device, since the pixel electrode and the common electrode are repeatedly formed in parallel in pixel regions on the substrate, there are many regions having the steps formed thereon such that the problem of light leakage becomes serious.

The aforementioned problems in the rubbing alignment method are caused by the mechanism for providing physical contact between the rubbing roll and the substrate. Recently, to solve these problems of the rubbing alignment method, various studies have been conducted for providing a method for manufacturing an alignment layer which does not require physical contact. In particular, instead of using the rubbing alignment method, use of a photo-alignment method has been suggested, in which an alignment layer is produced by irradiating polarized ultraviolet (UV) rays onto a polymeric film. To align the liquid crystal molecules, the alignment layer must have an anisotropic structure, which can be formed when the polymeric film is anisotropically reacted with the polarized UV rays.

Although the photo-alignment method may address the above-described problems related to the rubbing alignment method described above, the photo-alignment method has a serious problem in that its anchoring energy is low. More specifically, with the rubbing alignment method, since the chains of the organic polymer are arranged in the constant direction as described above and grooves are uniformly formed over the surface of the substrate by rubbing, the alignment of the liquid crystal molecules is controlled by mechanical interaction between the grooves and the liquid crystals as well as by chemical interaction between the chains and the liquid crystal molecules. In the photo-alignment method, the alignment of the liquid crystals is only controlled by the chemical interaction between the chains and the liquid crystal molecules without forming the grooves on the surface of the alignment film. Accordingly, in comparison to the rubbing alignment method, the photo-alignment method has lower anchoring energy to the liquid crystal molecules and thus causes the problem of afterimage.

The photo-alignment method may be classified into a photo-decomposition reaction and a photo-dimerization reaction depending on a kind of reaction between the alignment material and the UV rays. FIG. 4 illustrates a related art photo-alignment method using a photo-decomposition reaction. In the photo-decomposition reaction, as shown in FIG. 4, when the polarized UV rays are irradiated onto the polymer alignment layer, a connection between side chains located in a polarized direction is decomposed, and thus only the side chains vertical to the polarized direction remain, thereby allowing the liquid crystal molecules to be aligned in that direction.

The problem of afterimage caused by the photo-alignment method is serious to such an extent that this method cannot be applied to large-scale production lines. In contrast, the rubbing alignment method has been used for a large production line in spite of the light leakage problems. There is a need for developing a method of initially aligning the liquid crystal molecules, which can overcome or minimize the problems of the rubbing alignment method and the photo-alignment method according to the related art.

### SUMMARY OF THE INVENTION

Accordingly, the present invention is directed to an LCD device and a method of fabricating the same, which substantially obviate one or more problems due to limitations and disadvantages of the related art.

An object of the present invention is to provide an LCD device and a method of fabricating the same with an alignment layer that does not cause light leakage.

An object of the present invention is to provide an LCD device and a method of fabricating the same with an alignment layer that has a high anchoring energy.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these objects and other advantages and in accordance with the purpose of the invention, a liquid crystal display device includes first and second substrates, an alignment layer formed on at least one of the substrates, and a liquid crystal layer formed between the substrates, wherein the alignment layer is formed of a polymeric material containing a polymer main chain and a photo-reaction group combined with the polymer main chain that generates a photo-dimerization reaction by UV rays.

In another aspect of the present invention, a method of fabricating an LCD device having first and second substrates includes coating an alignment layer on at least one of the substrates, rubbing the alignment layer, and irradiating polarized UV rays onto the alignment layer, wherein the alignment layer is formed of a polymeric material containing a polymer main chain and a photo-reaction group combined with the polymer main chain that generates a photo-dimerization reaction by UV rays.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exploded perspective view illustrating a related art TN mode LCD device;

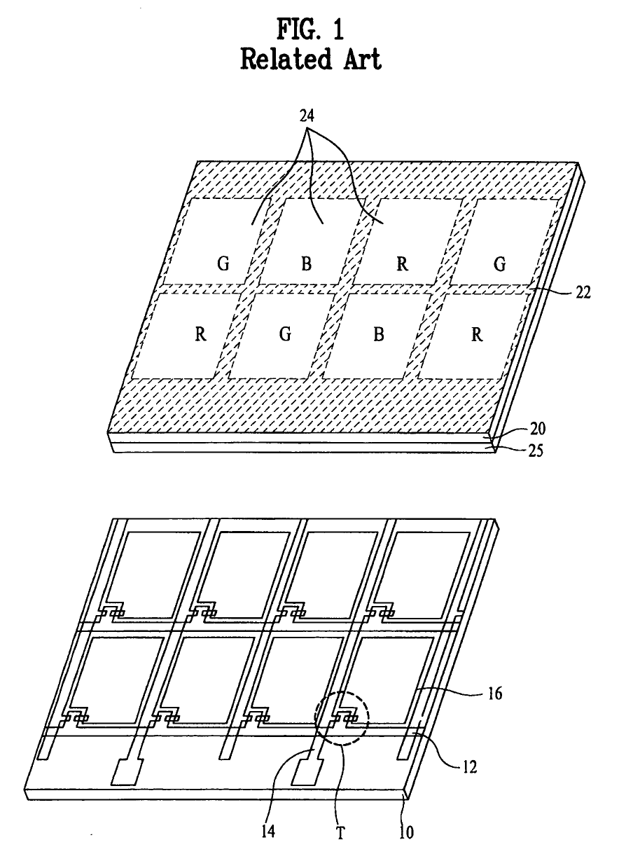

FIG. 2 is a schematic perspective view illustrating a disordered rubbing cloth;

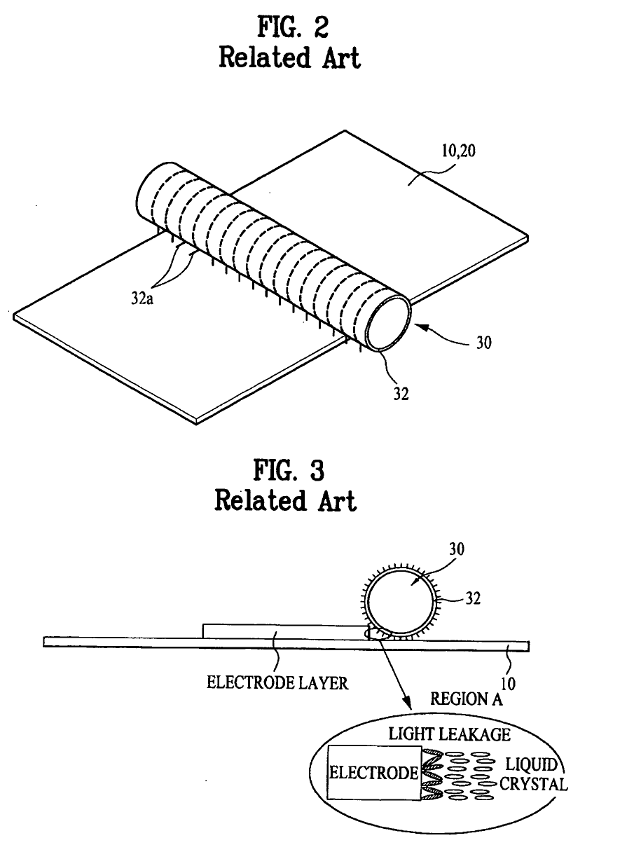

FIG. 3 is a cross-sectional view illustrating the rubbing cloth failing to contact the substrate;

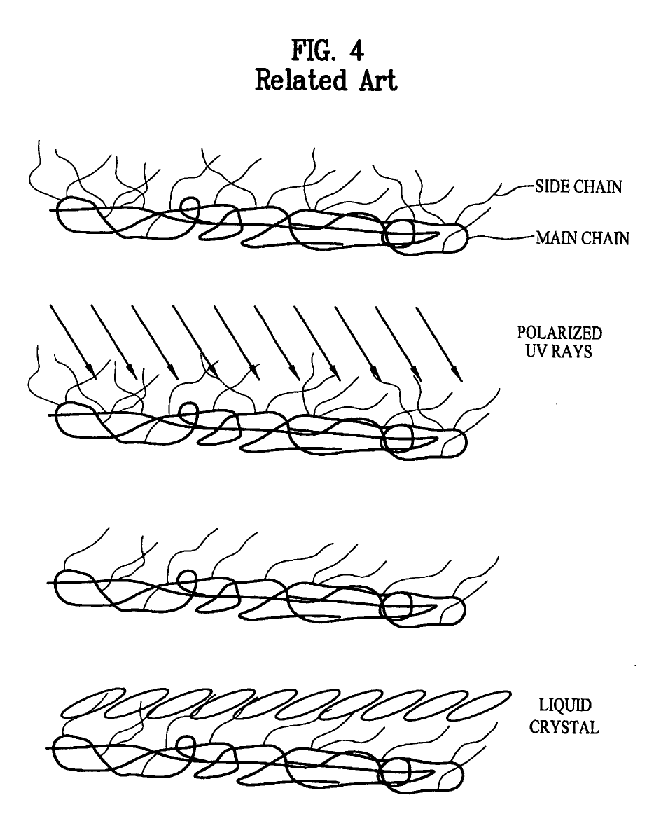

FIG. 4 illustrates a related art photo-alignment method using a photo-decomposition reaction;

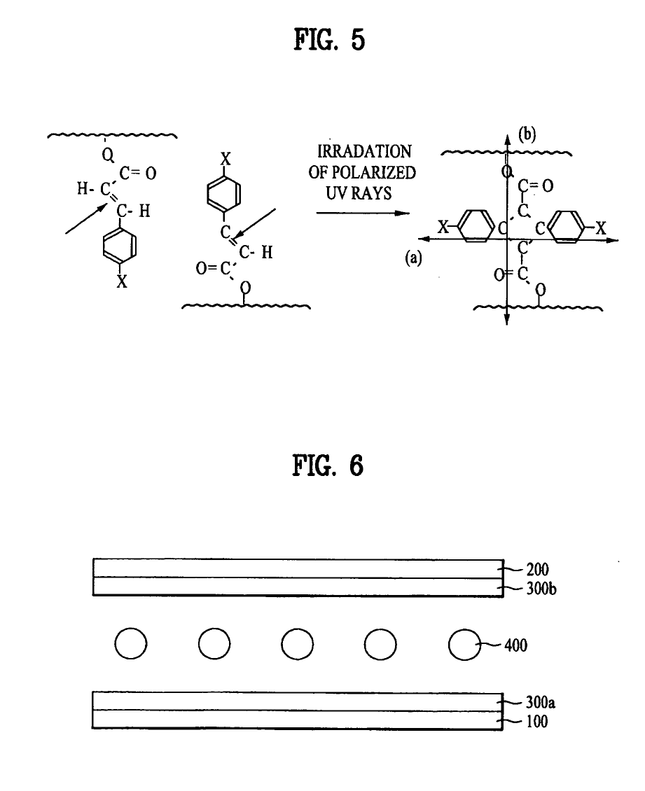

FIG. 5 illustrates a photo-alignment method using a photo-dimerization reaction according to an embodiment of the present invention;

FIG. 6 is a sectional view illustrating an LCD device according to the embodiment of the present invention; and

FIGS. 7A to 7E are process views illustrating a method of fabricating an LCD device according to the embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The embodiments of the present invention address the problems of the related art methods. For example, when arrangement of rubbing cloth becomes disordered or the rubbing cloth fails to contact the substrate, the alignment material coated on such a region is not aligned in the alignment direction. The inventors of the present application recognized this problem and conceived a method for causing the portion(s) of the alignment material not aligned by the rubbing alignment method to be aligned by a photo-alignment method uniquely configured to address this need. Also, a problem relating to low anchoring energy in the photo-alignment method is solved using the rubbing alignment method of the related art.

Embodiments of the present invention address a photo-dimerization reaction in the photo-alignment method. Therefore, an organic polymeric material containing a photo-reaction group that generates a photo-dimerization reaction by UV rays is used as the alignment layer of embodiments of the present invention. Hereinafter, the photo-alignment method and the reason why the photo-dimerization reaction is selected in embodiments of the present invention will be described.

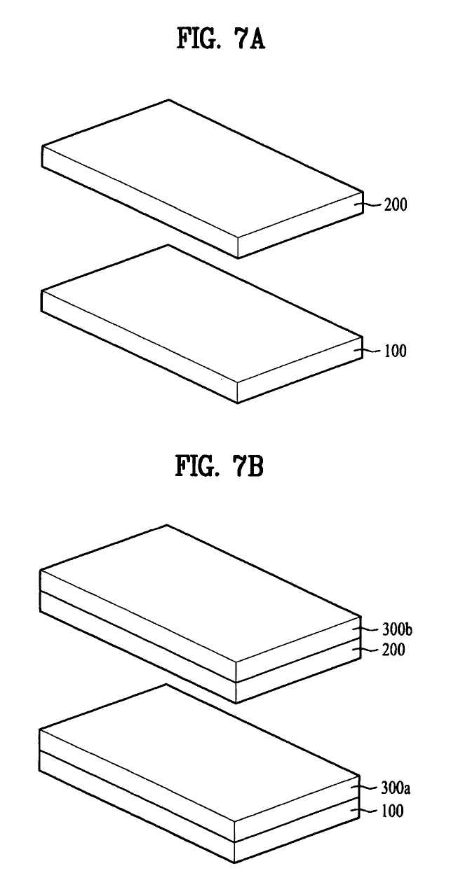

FIG. 5 illustrates a photo-alignment method using a photo-dimerization reaction according to an embodiment of the present invention. In the photo-dimerization reaction, as shown in FIG. 5, when the polarized UV rays are irradiated, double bonds (marked by an arrow) parallel to the polarization direction are broken and bonded to adjacent molecules. As a result, the liquid crystal molecules are aligned along a direction in which anisotropy is induced (that is, vertical or horizontal to the polarization direction).

There are several problems in the related art photo-alignment method using a photo-decomposition reaction. First, the anchoring energy of the alignment layer, which has been rubbed, is lowered by the decomposition. Second, afterimage occurs due to foreign matters generated by the photo-decomposition reaction. Third, the step of removing the foreign matters is additionally needed to solve the problem relating to afterimage.

Therefore, embodiments of the present invention uses the the photo-alignment method of photo-dimerization reaction, such that an alignment layer is provided aligned by both the rubbing alignment method and the photo-alignment method, which is based on the photo-dimerization reaction. The alignment layer is formed of a polymeric material containing a polymer main chain and a photo-reaction group combined with the polymer main chain that generates a photo-dimerization reaction by UV rays. The photo-reaction group is preferably selected from a group of a Cinnamoyl based material, a Chalcone based material, a Coumarine based material, and a Maleimide based material. The polymer main chain is preferably a polymeric material selected from a group of polyimide, polyamic acid, polyamide, polynorbornene, polyamideimide, polyvinyl, polyolefine, polystyrene, polyacrylate, poly(vinylchloride), polyether, polyester, polythioether, polysulfone, polyethersulfone, polyetheretherketon, polyurea, polyurethane, polybenzimidazol, polyacetal, and poly(vinylacetate).

In the method of fabricating an LCD device according to embodiments of the present invention, the rubbing process and the UV irradiation process may be performed simultaneously or separately (at different times). If the rubbing process and the UV irradiation process are performed separately (at different times), the rubbing process may be performed before the UV irradiation process, and vice versa. Further, the UV irradiation process may be performed over the entire surface of the substrate having the alignment material coated thereon, or may be performed at a region of the alignment film where a step is formed on the substrate. That is, when the rubbing cloth fails to contact the alignment film because of a step on the substrate, polarized UV rays may be irradiated to the region of the alignment film where the step is formed. The region can be specifically irradiated by shielding other regions with a mask. When the alignment of the rubbing cloth becomes disordered and/or steps are formed on the substrate, the polarized UV rays can be over the entire surface of alignment film on the substrate.

When the polarized UV rays are irradiated only at the step regions, different step regions are formed depending on whether the substrate is the thin film transistor substrate or the color filter substrate. Even when the substrate is the thin film transistor substrate, different step regions are formed depending on whether the LCD device is a TN mode or an IPS mode. Hereinafter, embodiments of the present invention will be described in more detail.

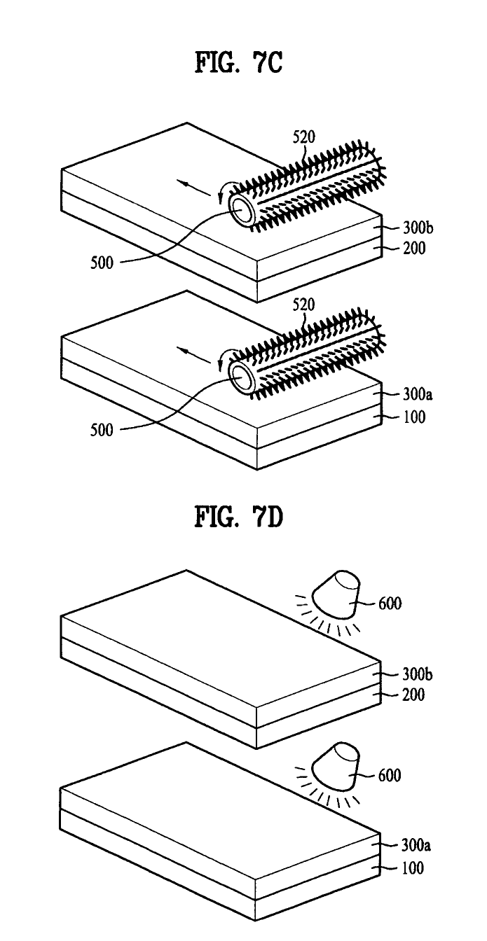

FIG. 6 is a cross-sectional view illustrating an LCD device according to an embodiment of the present invention. As shown in FIG. 6, the LCD device according to an embodiment of the present invention includes a lower substrate 100, an upper substrate 200, alignment layers 300a and 300b formed on the substrates 100 and 200, and a liquid crystal layer 400 formed between the substrates 100 and 200. Although not shown in detail, various modifications can be made in the structures of the lower substrate 100 and the upper substrate 200 depending on modes of the LCD device within the scope apparent to those skilled in the art. As such, the lower substrate 100 of the TN mode LCD device includes a gate line and a data line crossing each other to define a pixel region thereon; a thin film transistor is formed adjacent to the crossing of the gate line and the data line in the pixel region, the thin film transistor includes a gate electrode, a source electrode and a drain electrode; and a pixel electrode connected to the drain electrode of the thin film transistor. The upper substrate 200 of the TN mode LCD device includes a light-shielding layer; red, green and blue color filter layers formed in the light-shielding layer; and a common electrode formed on the color filter layers.

The lower substrate 100 of the IPS mode LCD device includes a gate line and a data line crossing each other to define a pixel region thereon; a thin film transistor formed adjacent to the crossing of the gate line and the data line in the pixel region, the thin film transistor includes a gate electrode, a source electrode and a drain electrode; a pixel electrode connected to the drain electrode of the thin film transistor; and a common electrode formed parallel to the pixel electrode. The upper substrate 200 of the IPS mode LCD device includes a light-shielding layer; red, green and blue color filter layers formed in the light-shielding layer; and an overcoat layer formed on the color filter layers. In addition, a spacer (not shown) is formed between the substrates 100 and 200 to maintain a cell gap between the substrates 100 and 200. A ball spacer or a column spacer may be used as the spacer.

The alignment layers 300a and 300b are formed of a polymeric material containing a polymer main chain and a photo-reaction group combined with the polymer main chain that generates a photo-dimerization reaction by UV rays as described below in more detail. Photo-reaction group generating photo-dimerization reaction by UV Rays will be explained. The photo-reaction group is preferably selected from a group of a Cinnamoyl based material, a Chalcone based material, a Coumarine based material, and a Maleimide based material.

The Cinnamoyl based material is preferably a compound expressed by the following chemical formula. 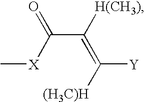
wherein X is selected from a group of —((CH₂)nO)m-, —O((CH₂)nO)m-, 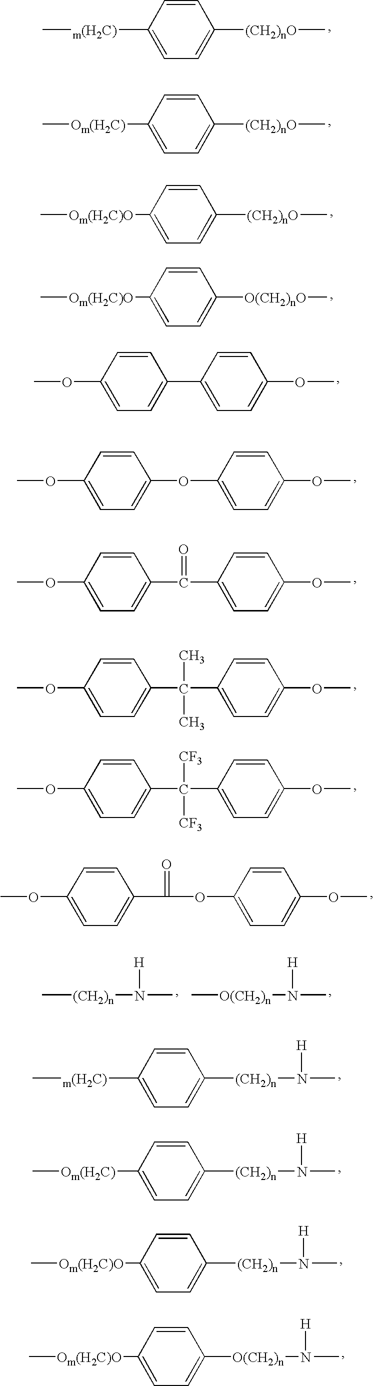 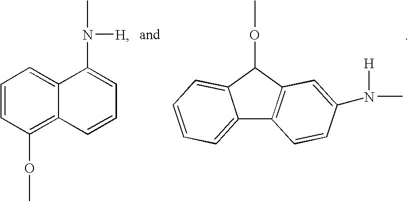
(m and n are positive numbers between 0 and 10), and Y is selected from a group of 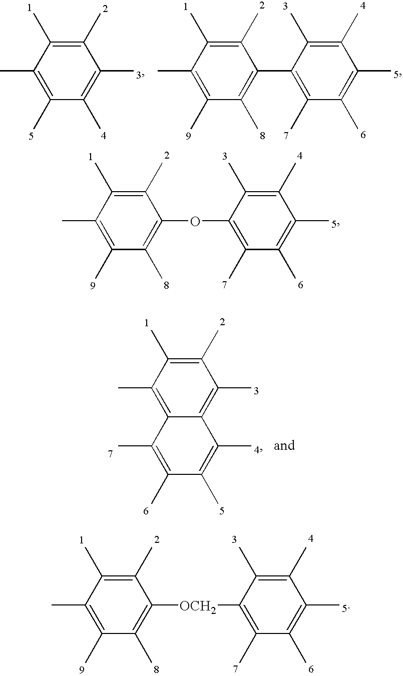
In the above Y, each of 1 to 9 is preferably selected from a group of -A, —(CA₂)nCA₃, —O(CA₂)nCA₃, —(O(CA₂)m)nCA₃, —O(CA₂)nOCA₃, —(O(CA₂)m)nOCA₃, 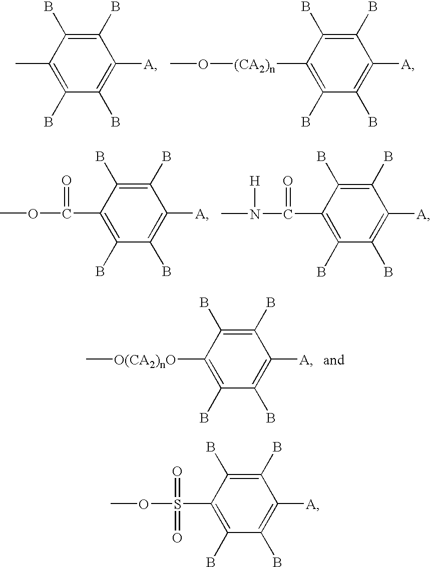
respectively (m and n are positive numbers between 0 and 10, and A and B respectively represent H, F, Cl, CN, CF₃ or CH₃). The Chalcone based material is preferably a compound expressed by the following chemical formula. 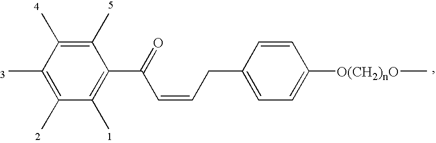
wherein n is a positive number between 0 and 10, each of 1 to 5 is preferably selected from a group of -A, —(CA₂)nCA₃, —O(CA₂)nCA₃, —(O(CA₂)m)nCA₃, —O(CA₂)nOCA₃, —(O(CA₂)m)nOCA₃, 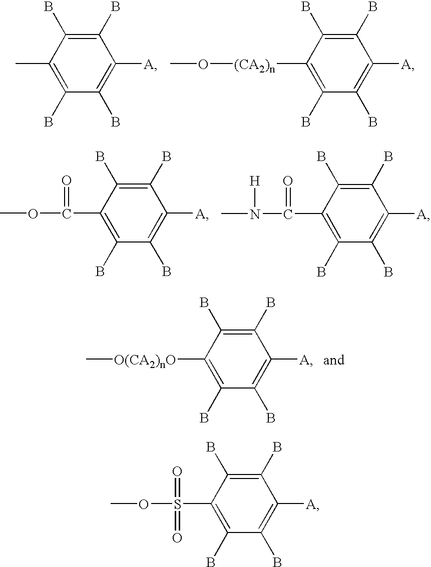
respectively (m and n are positive numbers between 0 and 10, and A and B respectively represent H, F, Cl, CN, CF₃ or CH₃).

The Coumarine based material is preferably a compound expressed by the following chemical formula. 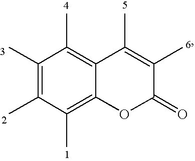
wherein each of 1 to 6 is preferably selected from a group of -A, —(CA₂)nCA₃, —O(CA₂)nCA₃, —(O(CA₂)m)nCA₃, —O(CA₂)nOCA₃, —(O(CA₂)m)nOCA₃, 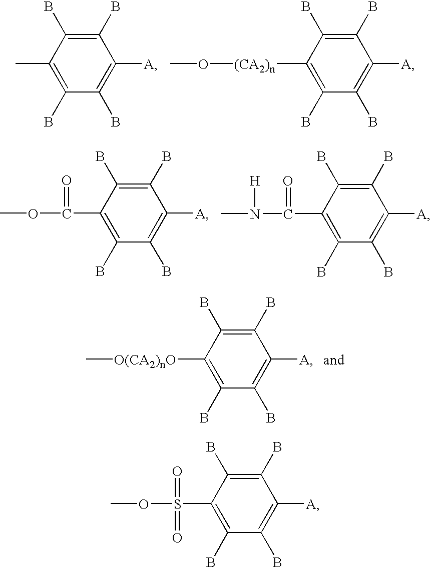
(m and n are positive numbers between 0 and 10, and A and B respectively represent H, F, Cl, CN, CF₃ or CH₃).

The Maleimide based material is preferably a compound expressed by the following chemical formula. 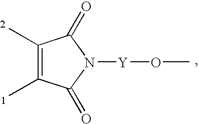
wherein Y is selected from a group of 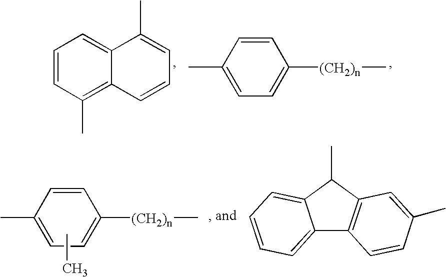
(n is a positive number between 0 and 10), and each of 1 and 2 is preferably selected from a group of —H, —F, —CH₃, —CF₃, —CN,

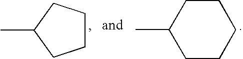

The polymer main chain is preferably a polymeric material selected from a group of polyimide, polyamic acid, polyamide, polynorbornene, polyamideimide, polyvinyl, polyolefine, polystyrene, polyacrylate, poly(vinylchloride), polyether, polyester, polythioether, polysulfone, polyethersulfone, polyetheretherketon, polyurea, polyurethane, polybenzimidazol, polyacetal, and poly(vinylacetate). More preferably, the polymer main chain is a polyimide compound or a polyamicacid compound expressed by the following chemical formula: 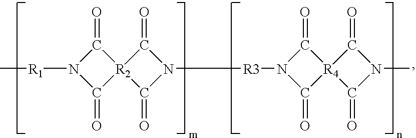
wherein m+n=1, 0≦m≦1, and 0≦n≦1 are obtained. The polyimide compound or the polyamicacid compound expressed by the above chemical formula is preferably fabricated by the reaction between amine and dianhydride. Dianhydride is preferably selected from a group of

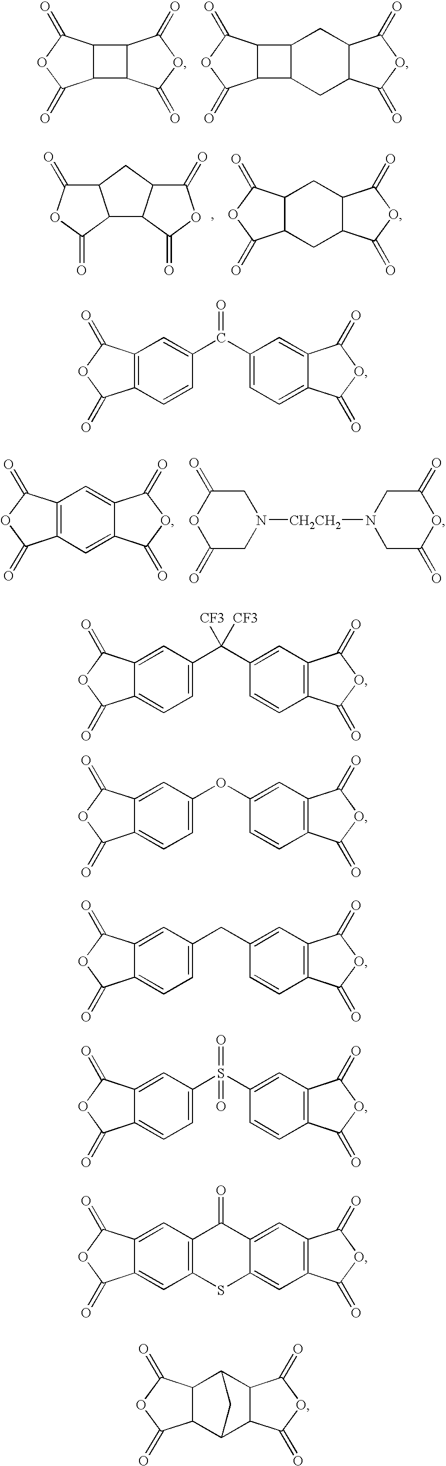

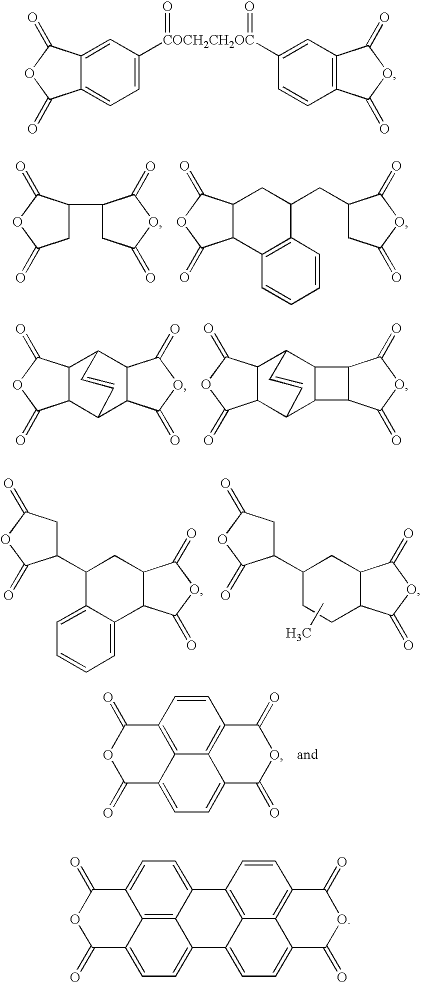

Amine is preferably selected from a group of (a) to (e) as follows.

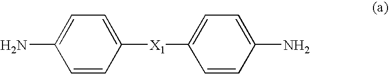

wherein, X1 is O, CO, 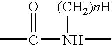
(n is a positive number between 0 and 20, and H may be replaced with F), 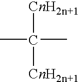
(n is a positive number between 0 and 20, and H may be replaced with F), 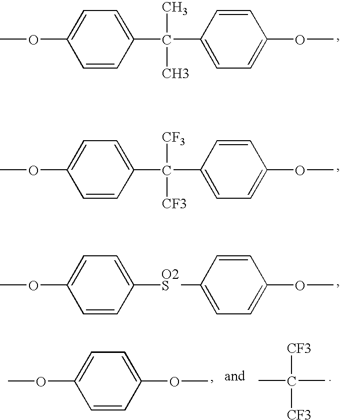
Further, X1 is an ortho-, meta-, para-, or their composite structure. 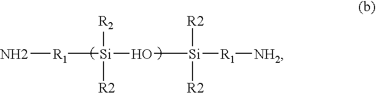
wherein R1 and R2 are (CH₂)n (n is a positive number between 0 and 10) or 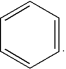 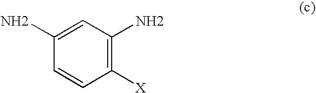
Wherein X is (CH₂)nH, CN, OCF₃, O(CH₂)nH, or O(CF₂)nCF₃. Further, X is an ortho-, meta-, para-, or their composite structure.

(d) NH₂—(CH₂)n-NH₂,
wherein n is a positive number between 1 and 20. 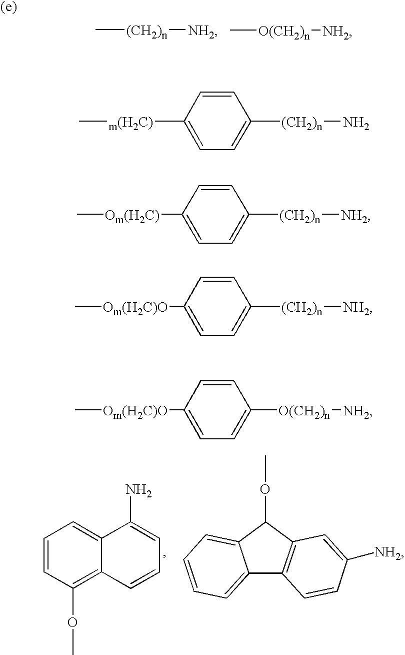
wherein m and n are positive numbers between 0 and 10.

The alignment layer is formed of a polymeric material obtained by a photo-reaction between the aforementioned polymer main chain and the aforementioned photo-reaction group as a side chain. If the polymer main chain is a polyimide compound or a polyamicacid compound fabricated by a reaction between dianhydride and amine, to combine the photo-reaction group, a hydrogen atom of the dianhydride may be replaced with the photo-reaction group or a hydrogen atom of the amine may be replaced with the photo-reaction group. The polymeric material constituting the alignment layer can be applied to the rubbing alignment method and can generate the photo-dimerization reaction of the photo-alignment method. The polymeric material has a λmax in the range of about 270 nm to 350 nm so as not to generate the photo-decomposition reaction of the photo-alignment method. In the polymeric material constituting the alignment layer, a para-structure is shown as the polymeric material including a benzene ring. However, the polymeric material including a benzene ring is not limited to the para-structure. That is, the polymeric material may be realized by an ortho-, meta-, para- or their composite structure.

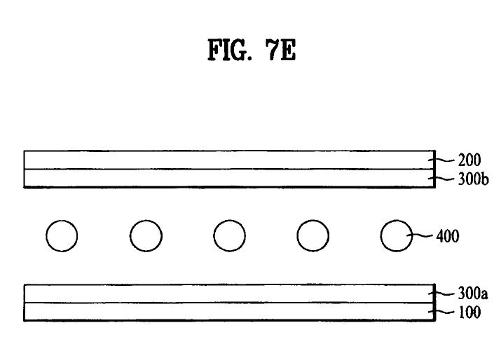

FIGS. 7A to 7E are process views illustrating a method of fabricating an LCD device according to the embodiment of the present invention. As shown in FIG. 7A, a lower substrate 100 and an upper substrate 200 are prepared. The detailed construction of the lower substrate 100 and the upper substrate 200 and the method for forming them can be varied by various methods known to those skilled in the art.

Afterwards, as shown in FIG. 7B, alignment layers 300a and 300b are coated on the lower substrate 100 and the upper substrate 200, respectively. Although the alignment layers 300a and 300b are formed on both substrates 100 and 200 in the drawing, they are not limited to such a case. Since the alignment layers 300a and 300b are formed of the same material as above, the detailed description of the material will be omitted.

Coating of the alignment layers 300 and 300b is completed by printing the alignment layers on the substrates 100 and 200 and curing the printed alignment layers. The step of printing the alignment layers is preferably performed by spin coating or roll coating after dissolving the alignment component in an organic solvent at the concentration of 1˜20 wt % and viscosity of 1˜1000 cps. The step of curing the printed alignment layers is preferably performed by twice curing at a temperature range between 60° C. and 80° C. and between 80° C. and 230° C. The alignment layers 300a and 300b are preferably coated at a thickness of 50 nm to 200 nm.

Afterwards, as shown in FIG. 7C, a rubbing process is performed on the substrates 100 and 200 coated with the alignment layers 300a and 300b. The rubbing process is performed by rubbing a rubbing roll 500 attached with a rubbing cloth 520 in a desired alignment direction.

Then, as shown in FIG. 7D, the polarized UV rays are irradiated to the substrates 100 and 200 where the rubbing process has completely performed, using a UV irradiation device 600. The UV irradiation process may be performed after the rubbing process. However, it should be noted that embodiments of the present invention are not limited to this sequence. Thus, the rubbing process may be performed after the UV irradiation process, or the rubbing process and the UV irradiation process may be performed at the same time. The rubbing process and the UV irradiation process are performed such that the alignment direction of the alignment layer portions from the rubbing process becomes identical with the alignment direction of the alignment layer portions from the UV irradiation process.

The UV rays may be irradiated over the entire surface of the substrates 100 and 200, or only at step regions where steps are formed on the substrates 100 and 200. In the case of the TN mode LCD device, the step may be formed at a region corresponding to the gate line, the data line, and the thin film transistor on the lower substrate 100. In the case of the IPS mode LCD device, the step may be formed at a region corresponding to the gate line, the data line and the thin film transistor and a region corresponding to the pixel electrode and the common electrode on the lower substrate 100. Therefore, the UV rays may be irradiated only to the step region while other regions of the alignment layer are shielded with a mask. The irradiation energy of the polarized UV rays is in the range of 10 mJ to 3000 mJ.

As for the polarized UV rays, either partially polarized UV rays or linearly polarized UV rays may be used. Additionally, the polarized UV rays may be irradiated obliquely or vertically to the substrate. In the case of the oblique irradiation, an irradiation angle is 60° or less. Irradiation of the polarized UV rays may be performed by a scan type light exposure method or by an entire light exposure method.

Afterwards, as shown in FIG. 7E, the substrates 100 and 200 are bonded to each other. The step of bonding the substrates 100 and 200 to each other may be performed by a vacuum injection method or a liquid crystal dropping method. In the vacuum injection method, the liquid crystal is injected using the pressure difference under the vacuum state after bonding the substrates 100 and 200 to each other. In the liquid crystal dropping method, the substrates are bonded to each other after dropping the liquid crystal onto any one of the substrates. As the size of the substrate is increased, the liquid crystal dropping method is preferred since the vacuum injection method requires an increased liquid injection time, resulting in reduction of productivity.

First, since the rubbing process is performed, high anchoring energy is obtained, thereby failing to generate afterimage. In addition, since the process of irradiating the polarized UV rays is performed, the LCD device does not suffer from the problem of light leakage generated when the arrangement of the rubbing cloth is disordered or when the rubbing cloth fails to contact the substrate in the rubbing alignment method. Moreover, since the polymeric material combined with the photo-reaction group that generates the photo-dimerization reaction is used as the alignment layer, photo-decomposition products are not generated by the UV irradiation process. Therefore, problems relating to afterimage caused by foreign matters and additional cleaning do not occur.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An LCD device comprising:
first and second substrates;
an alignment layer formed on at least one of the substrates; and
a liquid crystal layer formed between the substrates,
wherein the alignment layer is formed of a polymeric material containing a polymer main chain and a photo-reaction group combined with the polymer main chain that generates a photo-dimerization reaction by UV rays.

2. The LCD device as claimed in claim 1, wherein the photo-reaction group is selected from a group of a Cinnamoyl based material, a Chalcone based material, a Coumarine based material, and a Maleimide based material.

3. The LCD device as claimed in claim 2, wherein the photo-reaction group is a Cinnamoyl compound expressed by the following chemical formula: 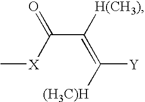
wherein X is selected from a group of —((CH₂)nO)m-, —O((CH₂)nO)m-, 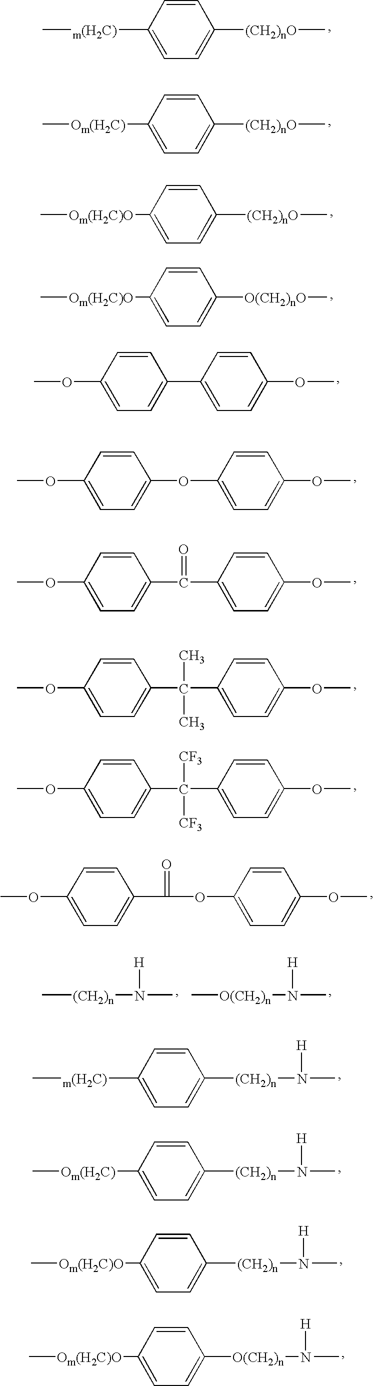 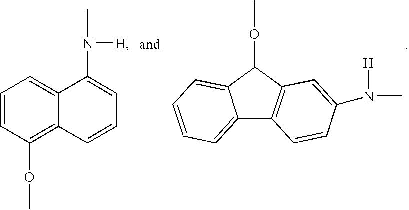
(m and n are positive numbers between 0 and 10), and Y is selected from a group of 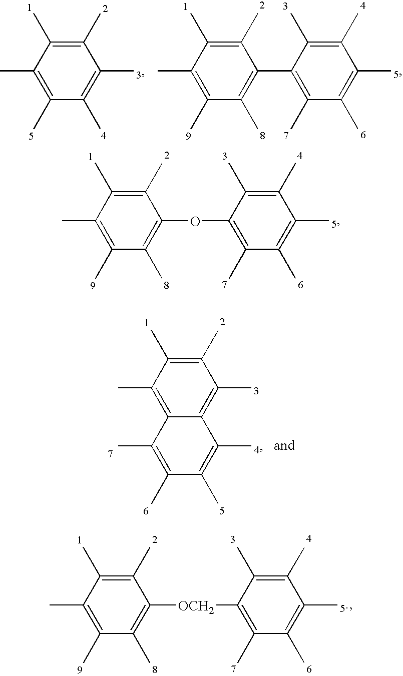
in the above Y, each of 1 to 9 is selected from a group of -A, —(CA₂)nCA₃, —O(CA₂)nCA₃, —(O(CA₂)m)nCA₃, —O(CA₂)nOCA₃, —(OCA₂)m)nOCA₂, 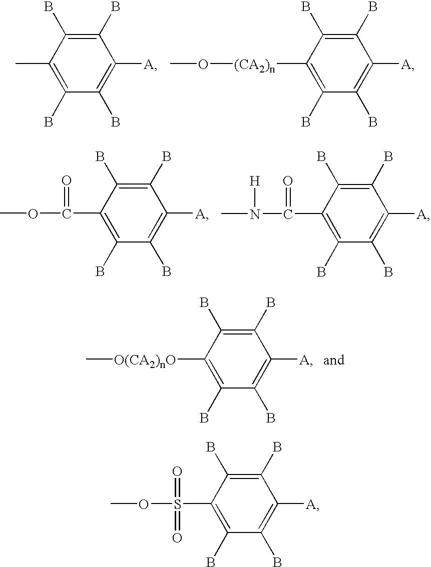
(m and n are positive numbers between 0 and 10, and A and B respectively represent H, F, Cl, CN, CF₃ or CH₃).

4. The LCD device as claimed in claim 2, wherein the photo-reaction group is a Chalcone compound expressed by the following chemical formula: 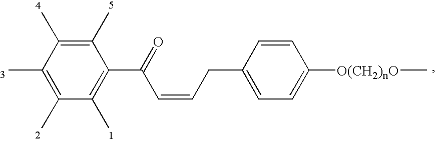
wherein n is a positive number between 0 and 10, each of 1 to 5 is selected from a group of -A, —(CA₂)nCA₃, —O(CA₂)nCA₃, —(O(CA₂)m)nCA₃, —O(CA₂)nOCA₃, —(O(CA₂)m)nOCA₃, 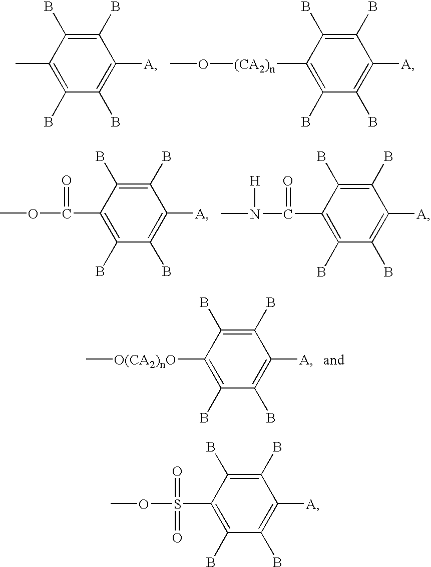
(m and n are positive numbers between 0 and 10, and A and B respectively represent H, F, Cl, CN, CF₃ or CH₃).

5. The LCD device as claimed in claim 2, wherein the photo-reaction group is a Coumarine compound expressed by the following chemical formula: 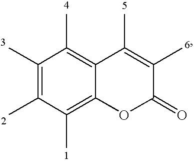
wherein each of 1 to 6 is selected from a group of -A, —(CA₂)nCA₃, —O(CA₂)nCA₃, —(O(CA₂)m)nCA₃, —O(CA₂)nOCA₃, —
(O(CA₂)m)nOCA₃, 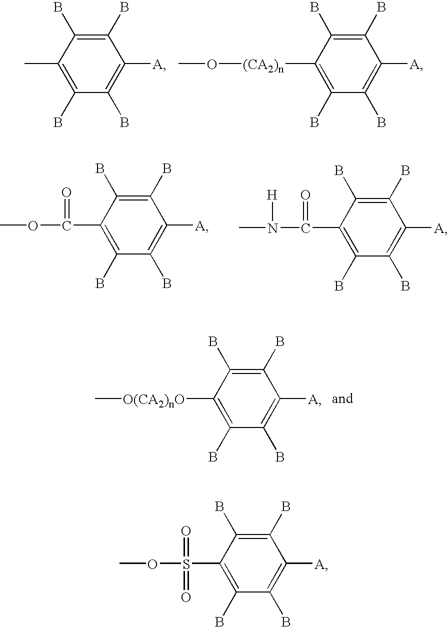
(m and n are positive numbers between 0 and 10, and A and B respectively represent H, F, Cl, CN, CF₃ or CH₃).

6. The LCD device as claimed in claim 2, wherein the photo-reaction group is a Maleimide compound expressed by the following chemical formula: 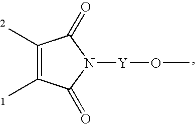
wherein Y is selected from a group of 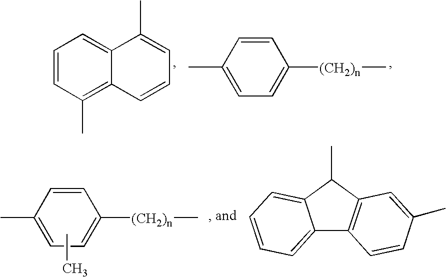
(n is a positive number between 0 and 10), and each of 1 and 2 is selected from a group of —H, —F, —CH₃, —CF₃, —CN,

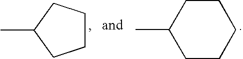

7. The LCD device as claimed in claim 1, wherein the polymer main chain is a polymeric material selected from a group of polyimide, polyamic acid, polyamide, polynorbornene, polyamideimide, polyvinyl, polyolefine, polystyrene, polyacrylate, poly(vinylchloride), polyether, polyester, polythioether, polysulfone, polyethersulfone, polyetheretherketon, polyurea, polyurethane, polybenzimidazol, polyacetal, and poly(vinylacetate).

8. The LCD device as claimed in claim 7, wherein the polymer main chain is a polyimide compound or a polyamicacid compound expressed by the following chemical formula: 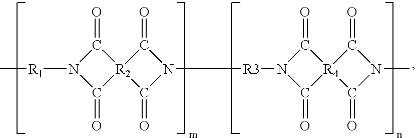
wherein m+n=1, 0≦m≦1 and 0≦n≦1 are obtained.

9. The LCD device as claimed in claim 8, wherein the polyimide compound or the polyamicacid compound is fabricated by a reaction between amine and dianhydride.

10. The LCD device as claimed in claim 9, wherein the dianhydride is selected from a group of

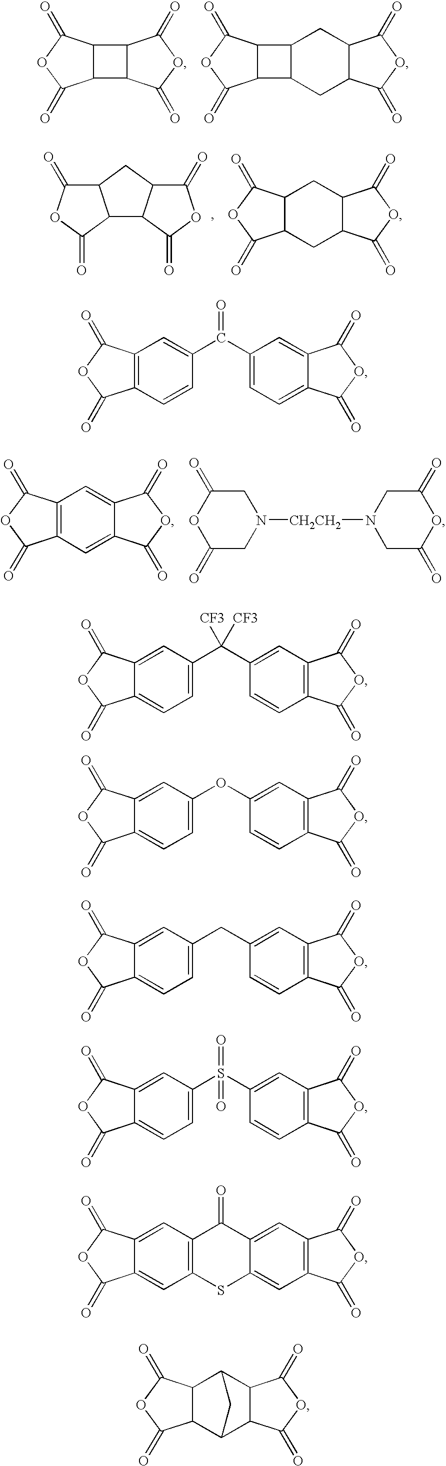

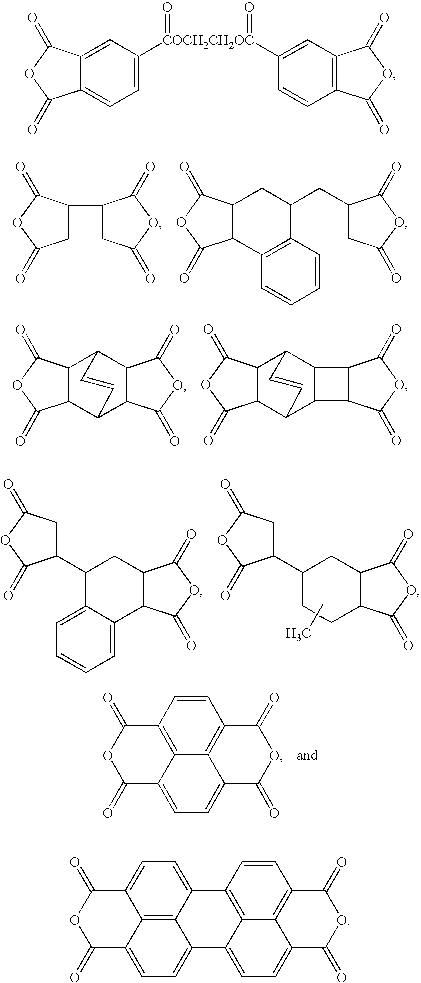

11. The LCD device as claimed in claim 10, wherein a hydrogen atom of the dianhydride is replaced with a Cinnamoyl compound.

12. The LCD device as claimed in claim 10, wherein a hydrogen atom of the dianhydride is replaced with a Chalcone compound.

13. The LCD device as claimed in claim 10, wherein a hydrogen atom of the dianhydride is replaced with a Coumarine compound.

14. The LCD device as claimed in claim 10, wherein a hydrogen atom of the dianhydride is replaced with a Maleimide compound.

15. The LCD device as claimed in claim 9, wherein the amine is selected from a group of (a) to (e):
(a) 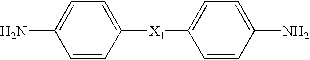
wherein, X1 is O, CO, 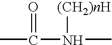
(n is a positive number between 0 and 20, and H may be replaced with F), 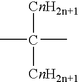
(n is a positive number between 0 and 20, and H may be replaced with F), 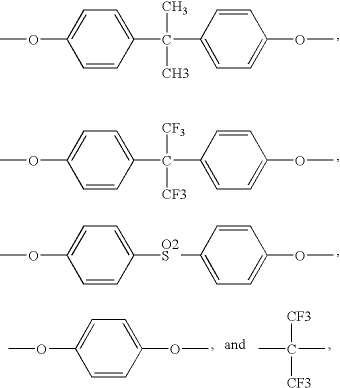
and X1 is an ortho-, meta-, para-, or their composite structure, 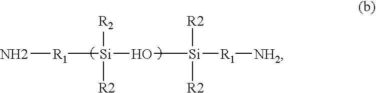
wherein R1 and R2 are (CH₂)n (n is a positive number between 0 and 10) or 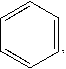 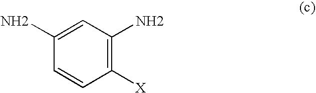
wherein X is (CH₂)nH, CN, OCF₃, O(CH₂)nH, or O(CF₂)nCF₃, and X is an ortho-, meta-, para-, or their composite structure,
(d)
NH₂—(CH₂)n-NH₂,
wherein n is a positive number between 1 and 20, and 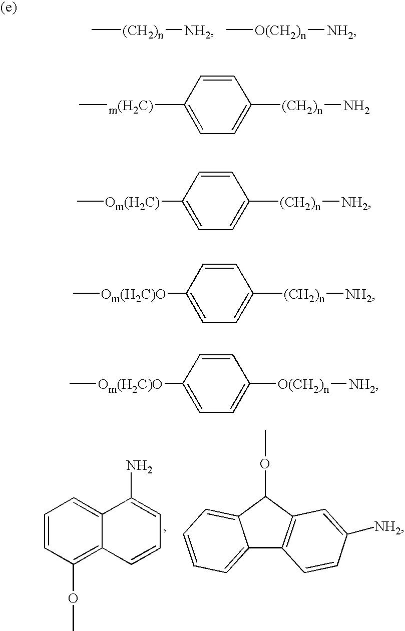
wherein m and n are positive numbers between 0 and 10.

16. The LCD device as claimed in claim 15, wherein a hydrogen atom of the amine is replaced with a Cinnamoyl compound.

17. The LCD device as claimed in claim 15, wherein a hydrogen atom of the amine is replaced with a Chalcone compound.

18. The LCD device as claimed in claim 15, wherein a hydrogen atom of the amine is replaced with a Coumarine compound.

19. The LCD device as claimed in claim 15, wherein a hydrogen atom of the amine is replaced with a Maleimide compound.

20. The LCD device as claimed in claim 1, wherein the polymeric material of the alignment layer has λmax in the range of about 270 nm to 350 nm.

21. The LCD device as claimed in claim 1, wherein the polymeric material includes a benzene ring is an ortho-, meta-, para- or their composite structure.

22. A method of fabricating an LCD device having first and second substrates, comprising:
coating an alignment layer on at least one of the substrates;
rubbing the alignment layer; and
irradiating polarized UV rays onto the alignment layer,
wherein the alignment layer is formed of a polymeric material containing a polymer main chain and a photo-reaction group combined with the polymer main chain that generates a photo-dimerization reaction by UV rays.

23. The method as claimed in claim 22, wherein an alignment direction of the alignment layer rubbed is identical with an alignment direction of the alignment layer irradiated with UV rays.

24. The method as claimed in claim 22, wherein the step of irradiating the UV rays is performed on the entire surface of the substrate.

25. The method as claimed in claim 22, wherein the step of irradiating the UV rays is performed only in a region of the alignment layer where step is formed on the substrate.

26. The method as claimed in claim 22, wherein the rubbing process is performed before the step of irradiating the UV rays.

27. The method as claimed in claim 22, wherein the step of irradiating the UV rays is performed before the rubbing process.

28. The method as claimed in claim 22, wherein the rubbing process and the step of irradiating the UV rays are performed simultaneously.

29. The method as claimed in claim 22, wherein the step of irradiating the UV rays is performed by irradiating partially polarized UV rays or linearly polarized UV rays.

30. The method as claimed in claim 22, wherein the polarized UV rays have an irradiation energy in the range of 10 mJ to 3000 mJ.

31. The method as claimed in claim 22, wherein the UV rays are irradiated vertically or obliquely to the substrate.

32. The method as claimed in claim 22, wherein the step of coating the alignment layer is performed by spin coating or roll coating after dissolving an alignment component in an organic solvent at the concentration of 1˜20 wt % and viscosity of 1˜10000 cps.

33. The method as claimed in claim 22, wherein the step of coating the alignment layer is performed to obtain a thickness of 50 nm to 200 nm.

34. The method as claimed in claim 22, further comprising bonding both substrates to each other.

35. The method as claimed in claim 34, wherein the step of bonding both substrates to each other includes dropping a liquid crystal onto any one of the substrates.

36. The method as claimed in claim 22, wherein the photo-reaction group is selected from a group of a Cinnamoyl based material, a Chalcone based material, a Coumarine based material, and a Maleimide based material.

37. The method as claimed in claim 36, wherein the photo-reaction group is a Cinnamoyl compound expressed by the following chemical formula: 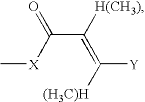
wherein X is selected from a group of —((CH₂)nO)m-, —O((CH₂)nO)m-, 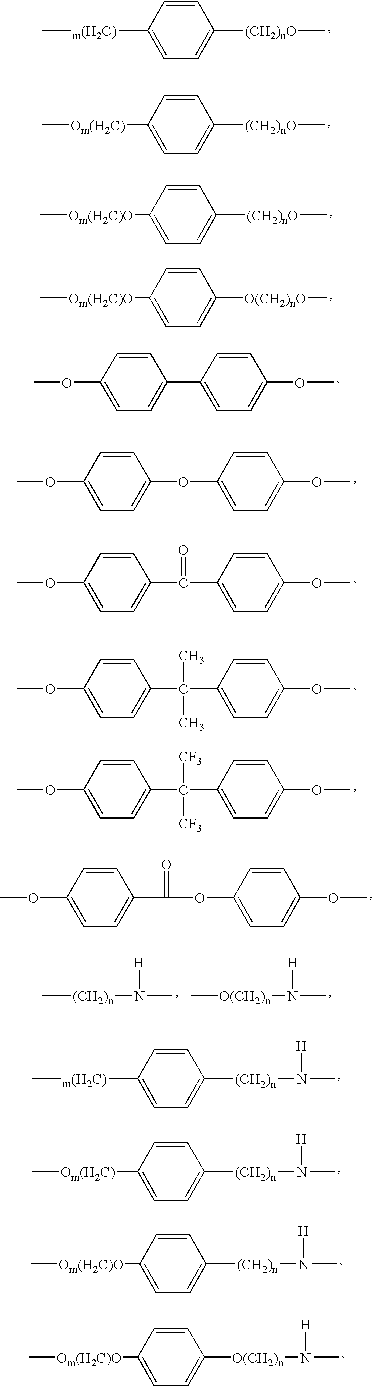 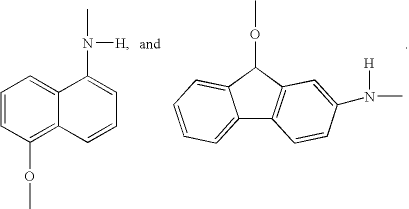
(m and n are positive numbers between 0 and 10), and Y is selected from a group of 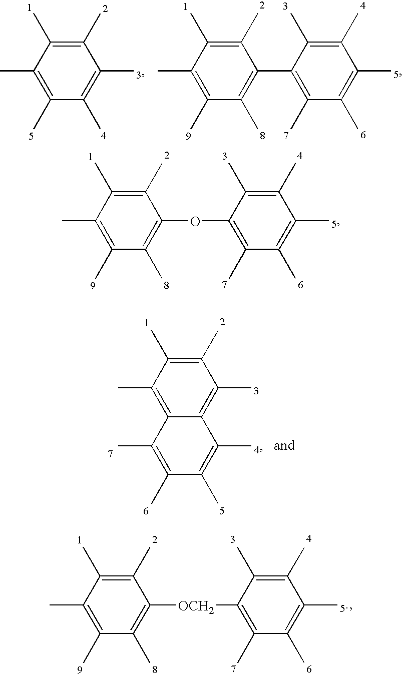
in the above Y, each of 1 to 9 is selected from a group of -A, —(CA₂)nCA₃, —O(CA₂)nCA₃, —(O(CA₂)m)nCA₃, —O(CA₂)nOCA₃, —(O(CA₂)m)nOCA₃, 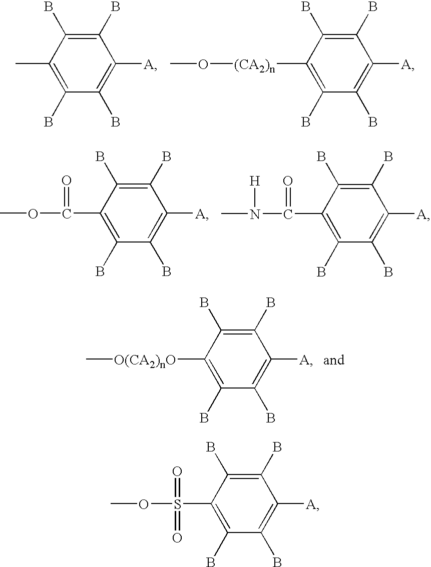
(m and n are positive numbers between 0 and 10, and A and B respectively represent H, F, Cl, CN, CF₃ or CH₃).

38. The method as claimed in claim 36, wherein the photo-reaction group is a Chalcone compound expressed by the following chemical formula: 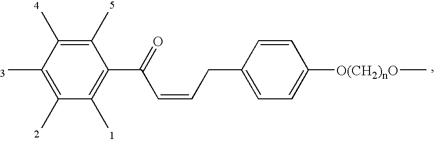
wherein n is a positive number between 0 and 10, each of 1 to 5 is selected from a group of -A, —(CA₂)nCA₃, —O(CA₂)nCA₃, —(O(CA₂)m)nCA₃, —O(CA₂)nOCA₃, —(O(CA₂)m)nOCA₃, 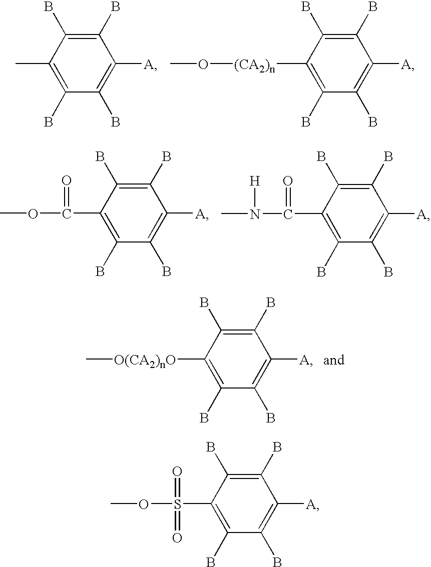
(m and n are positive numbers between 0 and 10, and A and B respectively represent H, F, Cl, CN, CF₃ or CH₃).

39. The method as claimed in claim 36, wherein the photo-reaction group is a Coumarine compound expressed by the following chemical formula: 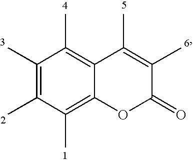
wherein each of 1 to 6 is selected from a group of -A, —(CA₂)nCA₃, —O(CA₂)nCA₃, —(O(CA₂)m)nCA₃, —O(CA₂)nOCA₃, —(O(CA₂)m)nOCA₃, 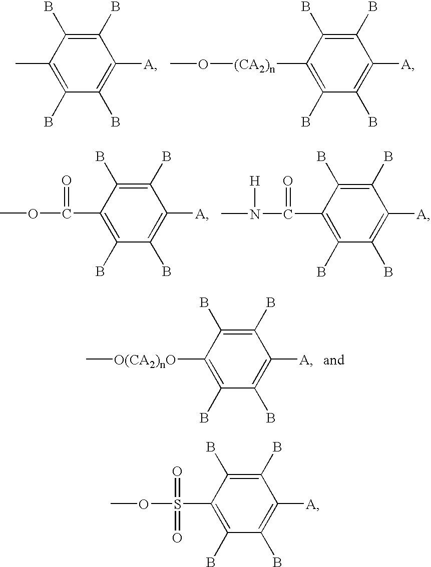
(m and n are positive numbers between 0 and 10, and A and B respectively represent H, F, Cl, CN, CF₃ or CH₃).

40. The method as claimed in claim 36, wherein the photo-reaction group is a Maleimide compound expressed by the following chemical formula: 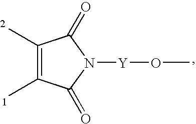
wherein Y is selected from a group of 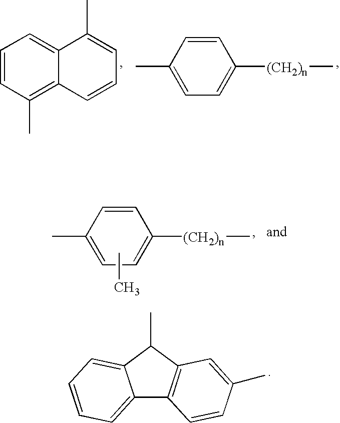
(n is a positive number between 0 and 10), and each of 1 and 2 is selected from a group of —H, —F, —CH₃, —CF₃, —CN,

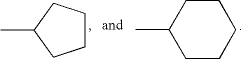

41. The method as claimed in claim 22, wherein the polymer main chain is a polymeric material selected from a group of polyimide, polyamic acid, polyamide, polynorbornene, polyamideimide, polyvinyl, polyolefine, polystyrene, polyacrylate, poly(vinylchloride), polyether, polyester, polythioether, polysulfone, polyethersulfone, polyetheretherketon, polyurea, polyurethane, polybenzimidazol, polyacetal, and poly(vinylacetate).

42. The method as claimed in claim 41, wherein the polymer main chain is a polyimide compound or a polyamicacid compound expressed by the following chemical formula: 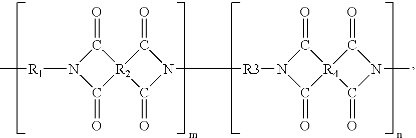
wherein m+n=1, 0≦m≦1, and 0≦n≦1 are obtained.

43. The method as claimed in claim 42, wherein the polyimide compound or the polyamicacid compound is fabricated by a reaction between amine and dianhydride.

44. The LCD device as claimed in claim 43, wherein the dianhydride is selected from a group of

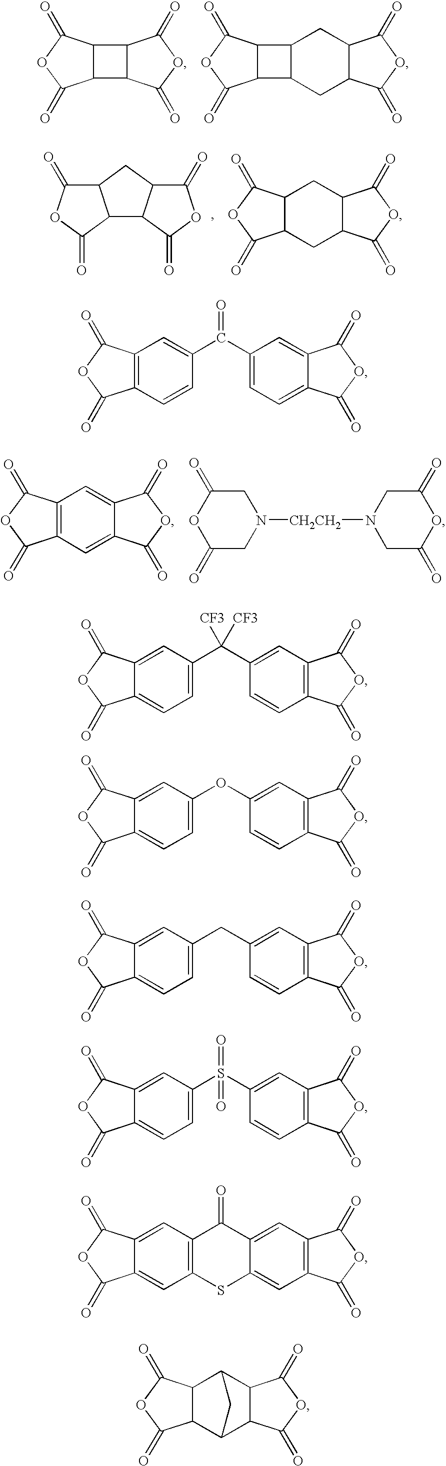

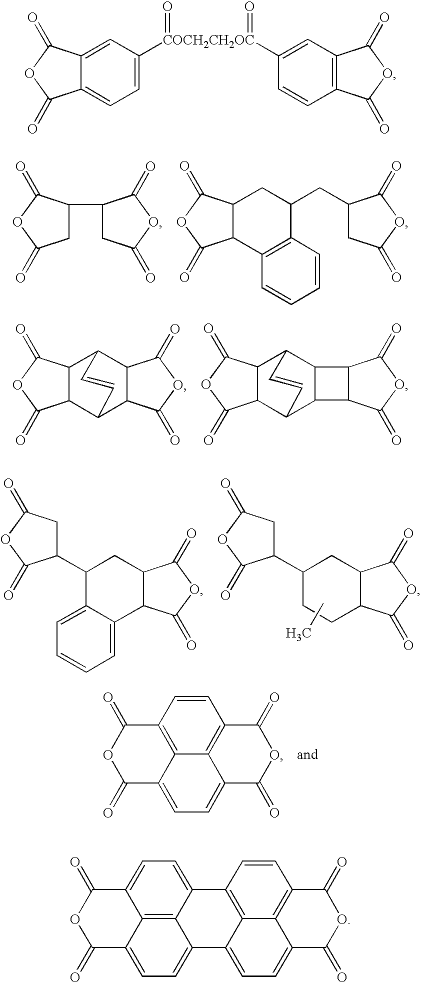

45. The method as claimed in claim 44, wherein a hydrogen atom of the dianhydride is replaced with the Cinnamoyl compound.

46. The method as claimed in claim 44, wherein a hydrogen atom of the dianhydride is replaced with the Chalcone compound.

47. The method as claimed in claim 44, wherein a hydrogen atom of the dianhydride is replaced with the Coumarine compound.

48. The method as claimed in claim 44, wherein a hydrogen atom of the dianhydride is replaced with the Maleimide compound.

49. The method as claimed in claim 43, wherein the amine is selected from a group of (a) to (e): 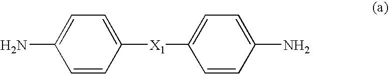
wherein, X1 is O, CO, 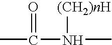
(n is a positive number between 0 and 20, and H may be replaced with F), 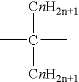
(n is a positive number between 0 and 20, and H may be replaced with F), 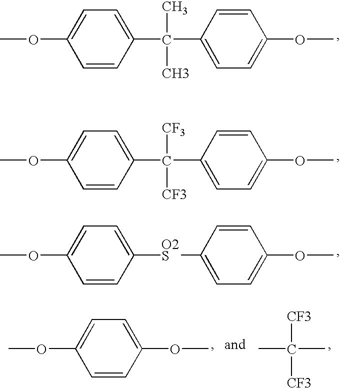
and X1 is an ortho-, meta-, para-, or their composite structure, 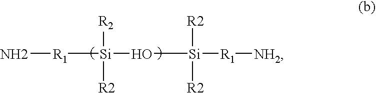
wherein R1 and R2 are (CH₂)n (n is a positive number between 0 and 10) or 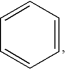 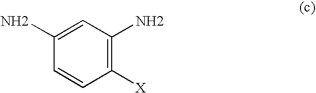
wherein X is (CH₂)nH, CN, OCF₃, O(CH₂)nH, or O(CF₂)nCF₃, and X is an ortho-, meta-, para-, or their composite structure,
(d)
NH₂—(CH₂)n-NH₂,
wherein n is a positive number between 1 and 20, and 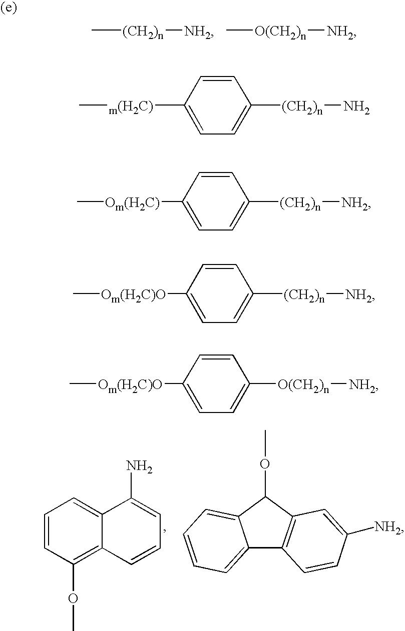
wherein m and n are positive numbers between 0 and 10.

50. The method as claimed in claim 49, wherein a hydrogen atom of the amine is replaced with the Cinnamoyl compound.

51. The method as claimed in claim 49, wherein a hydrogen atom of the amine is replaced with the Chalcone compound.

52. The method as claimed in claim 49, wherein a hydrogen atom of the amine is replaced with the Coumarine compound.

53. The method as claimed in claim 49, wherein a hydrogen atom of the amine is replaced with the Maleimide compound.

54. The method as claimed in claim 22, wherein the polymeric material of the alignment layer has λmax in the range of about 270 nm to 350 nm so as not to generate photo-decomposition due to UV rays.

55. The method as claimed in claim 22, wherein the polymeric material including a benzene ring is an ortho-, meta-, para- or their composite structure.
